(19) United States
(12) Patent Application Publication
(10) Pub. No.: US 2024/0149508 A1
(43) Pub. Date: May 9, 2024

(54) MANUFACTURING METHOD AND MANUFACTURING DEVICE OF IN-MOLD-COATED MOLDED PRODUCT

(71) Applicant: SEIKOH GIKEN Co., Ltd., Matsudo-shi (JP)

(72) Inventors: Masami SUZUKI, Matsudo-shi (JP); Norihiro KAKINUMA, Matsudo-shi (JP); Arihito IIDA, Matsudo-shi, Chiba (JP)

(21) Appl. No.: 18/503,182

(22) Filed: Nov. 7, 2023

(30) Foreign Application Priority Data
Nov. 8, 2022 (JP) 2022-178889

(51) Int. Cl. B29C 45/16; B29C 45/06

(52) U.S. Cl. CPC B29C 45/162; B29C 45/06

(57) ABSTRACT

A molding mold clamping/opening mechanism 10 for forming a molding base 4 between a molding mold 2 and a base mold 1 using thermoplastic resin as a material is provided separately from a coating mold clamping/opening mechanism 11 for coating the molding base 4 between a coating mold 6 and the base mold 1 using thermosetting resin as a material and at least one of a mold clamping force, a duration time of clamping, a mold clamping timing between the molding mold 2 and the base mold 1 and a mold temperature of the molding mold 2 is different from the mold clamping force, the duration time of clamping, the mold clamping timing between the coating mold 6 and the base mold 1 and the mold temperature of the coating mold 6.

### CROSS-REFERENCE TO RELATED APPLICATIONS

This patent specification is based on Japanese patent application, No. 2022-178889 filed on Nov. 8, 2022 in the Japan Patent Office, the entire contents of which are incorporated by reference herein.

### PRIOR ART

[Patent document 1] Japanese Patent No. 3617807
[Patent document 2] Japanese Unexamined Patent Application Publication No. 2009-101670

### BACKGROUND OF THE INVENTION

The present invention relates to a manufacturing method and a manufacturing device of an in-mold-coated molded product for forming a molding base in a mold using a thermoplastic resin and then coating the molding base with a thermosetting resin in the mold. In particular, optimum molding conditions and optimum coating conditions can be specified each for the molding process of the molding base using the thermoplastic resin and the coating process of the molding base with the thermosetting resin.

In recent years, as the interest in environmental problems has grown, In-Mold Coating (IMC) method has gained attention as alternative technology of the coating that provides high CO₂ emission reduction effect without using an organic solvent. The IMC is the technology of injecting a liquid-type functional coating agent (e.g., thermosetting resin) into a gap formed between an outer surface of the molding base and an inner surface of the mold by using the mold which is used for forming the molding base and heating it for coating the outer surface of the molding base.

The followings are the examples of the characteristics of the IMC. (1) The EMC is environmentally friendly and safe for human body since it does not utilize organic solvent commonly used in general spray coating. (2) Specialized equipment for performing the coating process (e.g., spraying, heat treatment by oven) is not required. (3) The rate (coating efficiency) of the material (coating material) formed on the outer surface of the molding base acting as the coating is extremely high with extremely low waste since the coating material is not diluted with the organic solvent. The EMC is used for the purpose of improving the quality of the surface of the molded product and simplifying the coating process. In particular, the EMC is widely used for the exterior components and the like in the automobile industry having a high demand for an outer appearance and quality.

Meanwhile, it is known as the IMC that an in-mold coating molding method for forming a thermoplastic resin molded product in molds, injecting a thermosetting resin acting as a coating agent into a gap (injection space) formed between the surface of the thermoplastic resin molded product and a cavity surface of the molds by slightly opening (core-backing) the molds, and clamping the molds again and solidifying the thermosetting resin so that the thermosetting resin is coated on the surface of the molded product of the thermoplastic resin (shown in Patent document 1). However, in the above described so-called core back method, when manufacturing an in-mold-coated molded product, the time of the resin molding process and the time of the process of injecting and hardening the coating agent are added. Thus, the entire molding cycle becomes longer and this causes to increase the manufacturing cost. In addition, the space for injecting the coating agent formed by opening the molds is essentially nonexistent along the surface in the direction of mold opening/clamping. Therefore, operation is only possible on the surface that intersects the mold opening/clamping direction.

As the IMC capable of solving the above described problem, the manufacturing method of the in-mold coated product is known. This method uses a coating forming mold for coating the surface of the molded product in addition to a reverse-surface forming mold and a front-surface forming mold of the molded product (shown in Patent document 2). The above described manufacturing method of the in-mold coated product is the method of using a manufacturing device having the reverse-surface forming mold, the front-surface forming mold and the coating forming mold. After a molded product is molded between the reverse-surface forming mold and the front-surface forming mold, the reverse-surface forming mold and the front-surface forming mold are opened in a state that the reverse-surface forming mold holds the molded product, the front-surface forming mold facing the reverse-surface forming mold is replaced with the coating forming mold, the reverse-surface forming mold holding the molded product and the coating forming mold are clamped together, the thermosetting resin is injected into a coating gap formed between the molded product and the coating forming mold acting as a coating agent and the thermosetting resin is hardened. Thus, the surface of the molded product is coated with the thermosetting resin.

As an example of the above described manufacturing method of the in-mold coated product, FIG. 3 and FIG. 4 of Patent document 2 disclose the configuration where a first reverse-surface forming mold and a second reverse-surface forming mold having the same shape are arranged side by side on one (movable platen) of a pair of platens (fixed platen, movable platen), which are moved to approach to each other and separate from each other, the front-surface forming mold is arranged on the other (fixed platen) facing the first reverse-surface forming mold and the coating forming mold is arranged on the other (fixed platen) facing the second reverse-surface forming mold. The movable platen is rotatable around the axis directed along the mold clamping/opening direction. When the movable platen is rotated, the position of the first reverse-surface forming mold and the position of the second reverse-surface forming mold are switched with each other. Thus, the first reverse-surface forming mold faces the coating forming mold and the second reverse-surface forming mold faces the front-surface forming mold.

In the above described configuration, when the movable platen is moved to approach to or separate from the fixed platen, the mold clamping/opening between the first reverse-surface forming mold and the front-surface forming mold and the mold clamping/opening between the second reverse-surface forming mold and the coating forming mold are simultaneously performed. In addition, when the movable platen is rotated, the mold clamping/opening between the second reverse-surface forming mold and the front-surface forming mold and the mold clamping/opening between the first reverse-surface forming mold and the coating forming mold are simultaneously performed. Thus, the molding process and the coating process can be simultaneously performed with low waste in the molding cycle. In addition, the coating is applied by using the coating forming mold having the different shape from the front-surface forming mold, and there is no need for core-backing the front-surface forming mold to the first and second reverse-surface forming molds. As a result, the space of injecting the coating agent can be secured regardless of the mold opening/clamping direction.

### SUMMARY OF THE INVENTION

However, in the above described system where the operation of clamping and opening the mold is achieved by a pair of mold clamping mechanisms (i.e., the system composed of one fixed platen and one movable platen and where the molding process and the coating process are necessarily synchronized), it is not possible to independently specify the optimal manufacturing conditions (e.g., mold clamping force, duration time of clamping, mold clamping timing, mold temperature) for both the property of the thermoplastic resin used as the material of the molded product and the property of the thermosetting resin used as the material of the coating. Thus, if one of the quality of the molded product and the quality of the coating is prioritized, the quality of the other may be negatively affected. Therefore, there is a room for improvement in the quality of the in-mold-coated molded product being manufactured.

Considering the above described situations, the purpose of the present invention is to provide a manufacturing method and a manufacturing device of an in-mold-coated molded product for molding a molding base in a mold using a thermoplastic resin as a material followed by coating a surface of the molding base with a thermosetting resin while enabling to specify the optimum molding condition and the optimum coating condition independently for the molding process of the molding base using the thermoplastic resin as the material and the coating process using the thermosetting resin as the material.

The present invention provides a manufacturing method of an in-mold-coated molded product, the manufacturing method including: clamping a base mold and a molding mold with each other, injecting a thermoplastic resin into a molding gap formed between the base mold and the molding mold and solidifying the thermoplastic resin to form a molding base; opening the base mold and the molding mold in a state that the molding base is held by the base mold and switching the molding mold facing the base mold to a coating mold; and clamping the coating mold and the base mold with each other, injecting a thermosetting resin into a coating gap formed between the molding base held by the base mold and the coating mold and hardening the thermosetting resin for coating a surface of the molding base with the thermosetting resin, wherein a molding mold clamping/opening mechanism for clamping and opening the base mold and the molding mold is provided separately from a coating mold clamping/opening mechanism for clamping and opening the base mold and the coating mold, and at least one of a mold clamping force between the base mold and the molding mold, a duration time of clamping between the base mold and the molding mold, a mold clamping timing between the base mold and the molding mold and a mold temperature of the molding mold when injection-molding the molding base from the thermoplastic resin by the clamping/opening mechanism is different from the mold clamping force between the base mold and the coating mold, the duration time of clamping between the base mold and the coating mold, the mold clamping timing between the base mold and the coating mold and the mold temperature of the coating mold when coating the molding base with the thermosetting resin by the coating mold clamping/opening mechanism (claim 1).

In the manufacturing method of the in-mold-coated molded product of the present invention, it is possible that the mold clamping force between the base mold and the molding mold when injection-molding the molding base from the thermoplastic resin by the molding mold clamping/opening mechanism is larger than the mold clamping force between the base mold and the coating mold when coating the molding base with the thermosetting resin by the coating mold clamping/opening mechanism, and the duration time of clamping between the base mold and the molding mold when injection-molding the molding base from the thermoplastic resin by the molding mold clamping/opening mechanism is shorter than the duration time of clamping between the base mold and the coating mold when coating the molding base with the thermosetting resin by the coating mold clamping/opening mechanism (claim 2).

The present invention provides a manufacturing device of an in-mold-coated molded product formed by: clamping a base mold and a molding mold with each other, injecting a thermoplastic resin into a molding gap formed between the base mold and the molding mold and solidifying the thermoplastic resin to form a molding base; opening the base mold and the molding mold in a state that the molding base is held by the base mold and switching the molding mold facing the base mold to a coating mold; and clamping the coating mold and the base mold with each other, injecting a thermosetting resin into a coating gap formed between the molding base held by the base mold and the coating mold and hardening the thermosetting resin for coating a surface of the molding base with the thermosetting resin, wherein a molding mold clamping/opening mechanism for clamping and opening the base mold and the molding mold is provided separately from a coating mold clamping/opening mechanism for clamping and opening the base mold and the coating mold, and at least one of a mold clamping force between the base mold and the molding mold, a duration time of clamping between the base mold and the molding mold, a mold clamping timing between the base mold and the molding mold and a mold temperature of the molding mold when injection-molding the molding base from the thermoplastic resin by the clamping/opening mechanism is different from the mold clamping force between the base mold and the coating mold, the duration time of clamping between the base mold and the coating mold, the mold clamping timing between the base mold and the coating mold and the mold temperature of the coating mold when coating the molding base with the thermosetting resin by the coating mold clamping/opening mechanism (claim 3).

In the manufacturing device of the in-mold-coated molded product of the present invention, it is possible that the mold clamping force between the base mold and the molding mold when injection-molding the molding base from the thermoplastic resin by the molding mold clamping/opening mechanism is larger than the mold clamping force between the base mold and the coating mold when coating the molding base with the thermosetting resin by the coating mold clamping/opening mechanism, and the duration time of clamping between the base mold and the molding mold when injection-molding the molding base from the thermoplastic resin by the molding mold clamping/opening mechanism is shorter than the duration time of clamping between the base mold and the coating mold when coating the molding base with the thermosetting resin by the coating mold clamping/opening mechanism (claim 4).

In the manufacturing device of the in-mold-coated molded product of the present invention, it is possible that a turntable facing the molding mold and the coating mold is provided, the base mold is comprised of two base molds and the two base molds are installed on the turntable at a 180° interval, a turntable-rotary-driving portion for rotating the turntable is provided for switching the turntable between a first state where one of the two base molds faces the molding mold and the other of the two base molds faces the coating mold and a second state where the other of the two base molds faces the molding mold and the one of the two base molds faces the coating mold, the molding mold clamping/opening mechanism is provided on a base which supports the turntable so as to be freely rotatable, the molding mold clamping/opening mechanism is configured to clamp and open the one of the two base molds and the molding mold in the first state, the molding mold clamping/opening mechanism is configured to clamp and open the other of the two base molds and the molding mold in the second state, the coating mold clamping/opening mechanism is provided on the base, the coating mold clamping/opening mechanism is configured to clamp and open the other of the two base molds and the coating mold in the first state, and the coating mold clamping/opening mechanism is configured to clamp and open the one of the two base molds and the coating mold in the second state (claim 5).

In the manufacturing device of the in-mold-coated molded product of the present invention, it is possible that a plurality of molding cores projected respectively from the one of the two base molds and the other of the two base molds so that the number of the plurality of molding cores is same between the one of the two base molds and the other of the two base molds; a plurality of molding cavities recessed from the molding mold in accordance with the plurality of molding cores; a plurality of coating cavities recessed from the coating mold in accordance with the plurality of molding cores; a plasticizing injection unit configured to inject the thermoplastic resin into the molding gap formed between the plurality of molding cores and the plurality of molding cavities when the one of the two base molds and the molding mold are clamped together or the other of the two base molds and the molding mold are clamped together by the molding mold clamping/opening mechanism; and a coating agent injector configured to inject the thermosetting resin into the coating gap formed between the molding base held by the plurality of molding cores and the plurality of coating cavities when the other of the two base molds and the coating mold are clamped together or the one of the two base molds and the coating mold are clamped together by the coating mold clamping/opening mechanism (claim 6).

In the manufacturing device of the in-mold-coated molded product of the present invention, it is possible that the coating agent injector is arranged at an approximately center of the coating mold so that an injection distances to the plurality of coating cavities are equal to each other (claim 7).

In the manufacturing device of the in-mold-coated molded product of the present invention, it is possible that a runner groove is formed on the molding mold so that the thermoplastic resin injected from the plasticizing injection unit is guided into the molding gap formed between the plurality of molding cores and the plurality of molding cavities at a constant length when the molding mold is clamped with the one of the two base molds or the other of the two base molds, and a coating agent groove is formed on the coating mold so that the thermosetting resin injected from the coating agent injector is guided into the coating gap formed between the molding base held by the plurality of molding cores and the plurality of coating cavities at a constant length along a runner formed by the runner groove when the coating mold is clamped with the other of the two base molds or the one of the two base molds (claim 8).

The manufacturing method and the manufacturing device of the in-mold-coated molded product of the present invention exhibit the following effects.

(1) The molding mold clamping/opening mechanism for clamping and opening the base mold and the molding mold to form the molding base from the thermoplastic resin is provided separately from the coating mold clamping/opening mechanism for clamping and opening the base mold and the coating mold for coating the surface of the molding base with the thermosetting resin. Thus, the optimum conditions of the molding process of the molding base using the thermoplastic resin as the material and the optimum conditions of the coating process using the thermosetting resin as the material can be independently specified.

(2) Namely, at least one of the mold clamping force between the base mold and the molding mold, the duration time of clamping between the base mold and the molding mold, the mold clamping timing between the base mold and the molding mold and the mold temperature of the molding mold when injection-molding the molding base from the thermoplastic resin by the clamping/opening mechanism is different from the mold clamping force between the base mold and the coating mold, the duration time of clamping between the base mold and the coating mold, the mold clamping timing between the base mold and the coating mold and the mold temperature of the coating mold when coating the molding base with the thermosetting resin by the coating mold clamping/opening mechanism. Thus, both the quality of the molding base and the quality of the coating can be satisfied.

(3) Accordingly, in the manufacturing method and the manufacturing device of the in-mold-coated molded product for molding the molding base in the mold using the thermoplastic resin as the material to form the molding base followed by coating the surface of the molding base with the thermosetting resin, the optimum molding conditions for the molding of the molding base using the thermoplastic resin as the material as well as the optimum coating conditions for the coating using the thermosetting resin as the material can be specified independently. Thus, both the quality of the molding base and the quality of the coating can be achieved.

Accordingly, the quality of the manufactured in-mold-coated molded product can be improved.

### BRIEF DESCRIPTION OF DRAWINGS

FIG. 1 is a partially transparent perspective view of a manufacturing device (horizontal injection) of an in-mold-coated molded product concerning an embodiment of the present invention.

FIG. 2 is a cross-sectional view cut along Il-Il line of FIG. 1.

FIG. 3 is a front view (partial cross-section) of FIG. 1.

FIG. 4 is a front view (partial cross-section) showing the subsequent process of FIG. 3.

FIGS. 5A to 5C are explanatory drawings showing a state of molding a molding base (made of thermoplastic resin). FIG. 5A is a bottom view (plan view viewed from parting surface) of a molding mold showing molding cavities, a runner groove and a sprue groove formed on a lower surface (parting surface) of the molding mold. FIG. 5B is a cross-sectional view of the base mold and the molding mold cut along b-b line of FIG. 5A (before injection molding). FIG. 5C is a cross-sectional view showing the subsequent process of FIG. 5B (after injection molding).

FIG. 6 is a perspective view showing a state that the molding base formed by the molding mold shown in FIG. 5 and the base mold shown in FIG. 2 is virtually removed from the molding core of the base mold.

FIGS. 7A to 7C are explanatory drawings showing a state of coating the molding base with a thermosetting resin. FIG. 7A is a bottom view (plan view viewed from parting surface) of a coating mold showing a coating cavity, a coating agent groove and a coating agent sprue passage formed on a lower surface (parting surface) of the base mold. FIG. 7B is a cross-sectional view (before coating) of the base mold, the runner and the coating mold cut along b-b line of FIG. 7A. FIG. 7C is a cross-sectional view (after injection molding) showing the subsequent process of FIG. 7B.

FIG. 8 is a partially transparent perspective view of the manufacturing device of the in-mold-coated molded product showing the subsequent process of FIG. 1.

FIG. 9A is a partially transparent perspective view of the manufacturing device of the in-mold-coated molded product showing the subsequent process of FIG. 8. FIG. 9B is a cross-sectional view of the manufactured in-mold-coated molded product.

FIG. 10 is a partially transparent perspective view of the manufacturing device (vertical injection) of the in-mold-coated molded product concerning a modified embodiment of the present invention.

FIG. 11 is a perspective view showing a state that the molding base formed by the manufacturing device (vertical injection) of the in-mold-coated molded product shown in FIG. 10 is held by the base mold.

FIG. 12 is a perspective view showing the coated product obtained by making the thermosetting resin flow as a coating agent along the runner shown in FIG. 11.

### DETAILED DESCRIPTION OF THE INVENTION

Hereafter, preferable embodiments of the present invention will be explained in detail with reference to the attached drawings. The dimensions, the materials, the other specific values and the like shown in the embodiments are merely examples for facilitating the understanding of the invention. Thus, these do not limit the present invention unless particularly mentioned. Note that the overlapping explanations will be omitted by assigning the same reference numeral to the element having the substantially same function and configuration in the specification and the drawings. In addition, the elements not directly related to the present invention are omitted in the drawings.

(Outline of Manufacturing Method of In-Mold-Coated Molded Product)

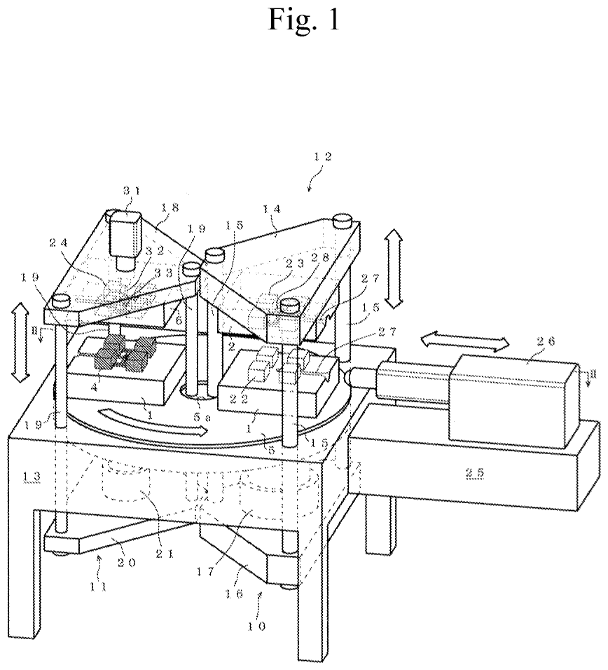

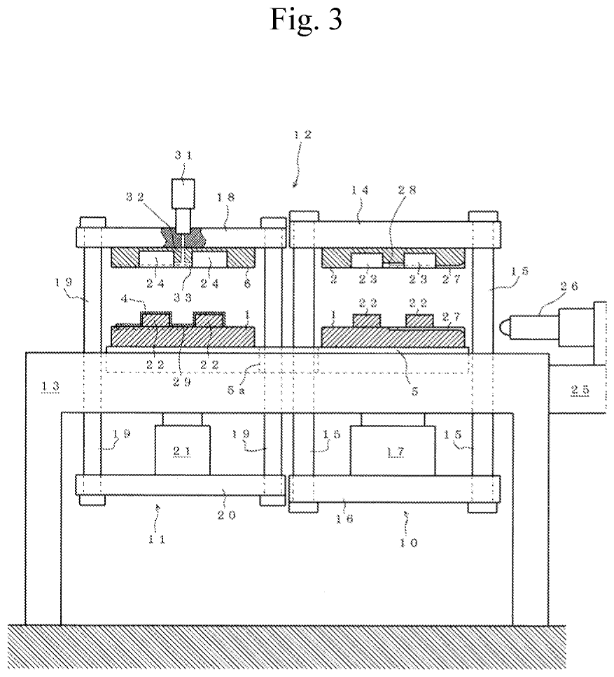

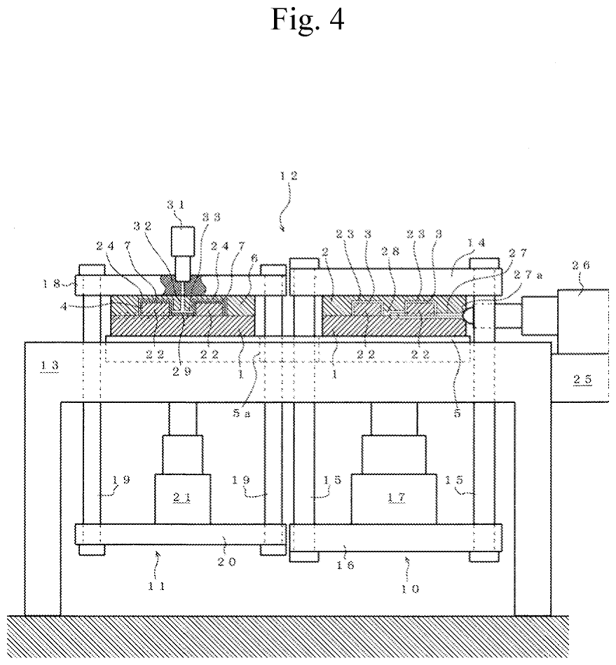

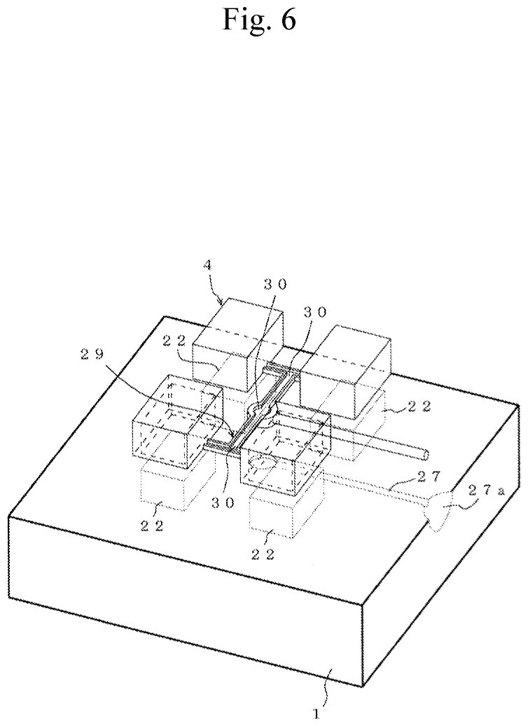

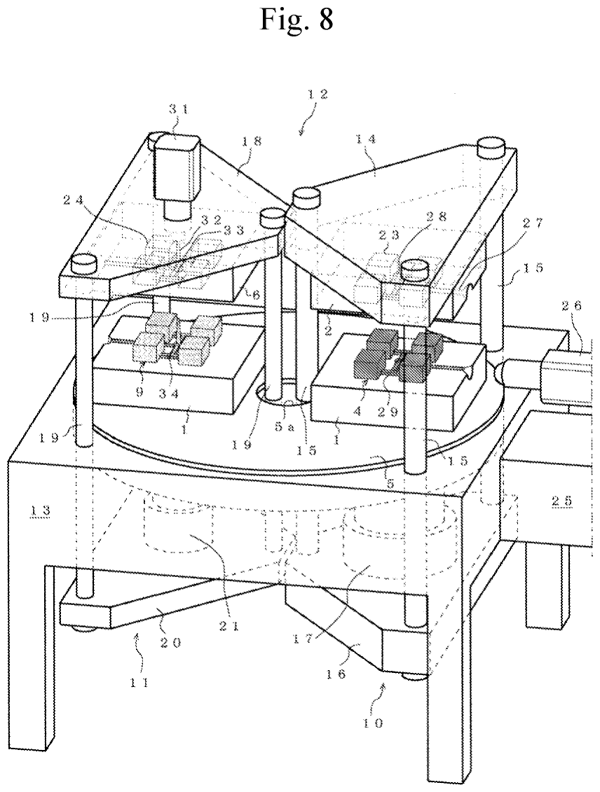

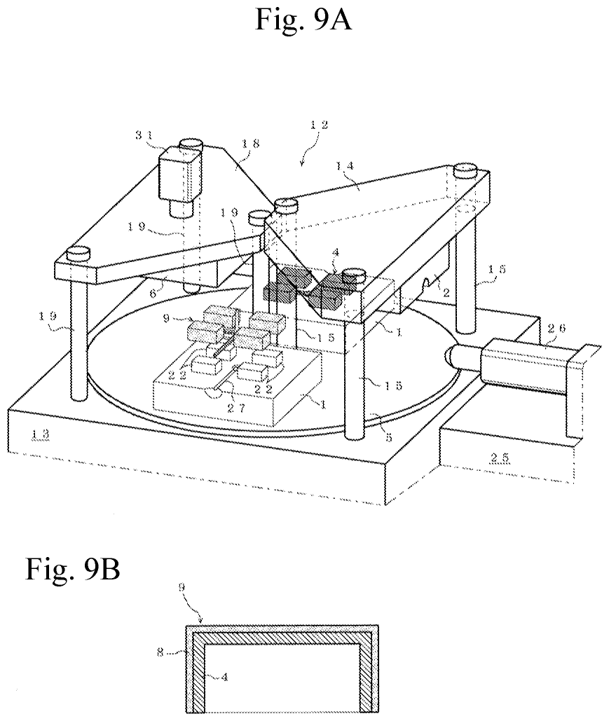

The manufacturing method of the in-mold-coated molded product of the present invention is configured to clamp a base mold 1 and a molding mold 2 shown in FIG. 1 and FIG. 3 with each other as shown in FIG. 4, inject a thermoplastic resin into a molding gap 3 formed between the base mold 1 and the molding mold 2 and solidify the thermoplastic resin to form a molding base 4 as shown in FIG. 6, open the base mold 1 and the molding mold 2 in a state that the molding base 4 is held by the base mold 1 as shown in FIG. 8, rotate a turntable 5 by 90 degrees as shown in FIG. 9 and then rotate the turntable 5 by 180 degrees (further 90 degrees) so that the molding base 4 held by the base mold 1 faces the coating mold as shown in FIG. 1, clamp a coating mold 6 and the base mold 1 with each other and inject a thermosetting resin into a coating gap 7 formed between the molding base 4 held by the base mold 1 and the coating mold 6 and harden the thermosetting resin as shown in FIG. 4. Thus, an in-mold-coated molded product 9 where the surface of the molding base 4 formed of the thermoplastic resin is coated with a coating layer 8 formed of the thermosetting resin is manufactured as shown in FIG. 9B.

The manufacturing method of the in-mold-coated molded product 9 of an embodiment of the present invention is characterized in that a molding mold clamping/opening mechanism 10 for clamping and opening one of the base molds 1 and the molding mold 2 is provided separately from a coating mold clamping/opening mechanism 11 for clamping and opening the other of the base molds 1 and the coating mold 6 as shown in FIG. 3 and FIG. 4 and characterized in that at least one of the mold clamping force between the base mold 1 and the molding mold 2, the duration time of clamping between the base mold 1 and the molding mold 2, the mold clamping timing between the base mold 1 and the molding mold 2 and the mold temperature of the molding mold 2 processed by the molding mold clamping/opening mechanism 10 is different from the mold clamping force between the base mold 1 and the coating mold 6, the duration time of clamping between the base mold 1 and the coating mold 6, the mold clamping timing between the base mold 1 and the coating mold 6 and the mold temperature of the coating mold 6 processed by the coating mold clamping/opening mechanism 11.

Because of this, it is possible to independently specify the optimum forming conditions for the forming process of the molding base 4 using the thermoplastic resin as the material and using the molding mold 2, the base mold 1 and the molding mold clamping/opening mechanism 10 and the optimum coating conditions for the coating process of the surface of the molding base 4 using the thermosetting resin as the material and using the coating mold 6, the base mold 1 and the coating mold clamping/opening mechanism 11. As shown in FIG. 9B, both the quality of the molding base 4 made of the thermoplastic resin and the quality of the coating layer 8 made of the thermosetting resin can be simultaneously satisfied for the manufactured in-mold-coated molded product 9. Hereafter, the manufacturing method and the manufacturing device of the in-mold-coated molded product 9 of the present embodiment will be described.

(Outline of Manufacturing Device 12 of In-Mold-Coated Molded Product 9)

As shown in FIG. 1, the manufacturing device 12 of the in-mold-coated molded product 9 of the present embodiment includes a base 13, a turntable 5 provided on the base 13 so as to be freely rotatable, two base molds 1 installed on the turntable 5 at a 180° interval, a molding mold 2 arranged to face one of the two base molds 1, a coating mold 6 arranged to face the other of the two base molds 1, a molding mold clamping/opening mechanism 10 for clamping and opening the one of the two base molds 1 and the molding mold 2, and the coating mold clamping/opening mechanism 11 for clamping and opening the other of the two base mold 1 and the coating mold 6.

(Turntable 5)

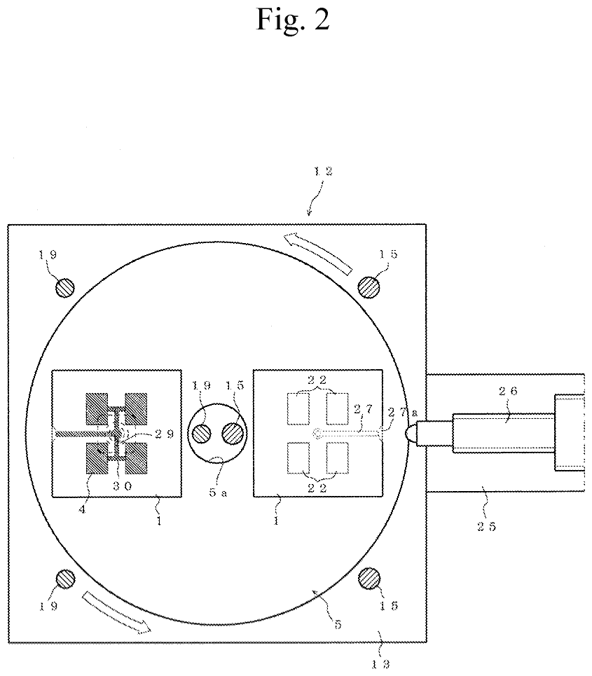

As shown in FIG. 2, the turntable 5 is formed in an annular shape (donut shape) having a hole 5a at the center. The two base molds 1 are arranged on the turntable 5 at a 180° (180 degrees) interval. A turntable-rotary-driving portion (e.g., stepping motor capable of precisely determining rotation position, illustration is omitted) for rotating the turntable 5 is configured to rotate the turntable 5 by 180 degrees. Thus, the turntable-rotary-driving portion has the function of switching the turntable 5 between the first state and the second state. In the first state, as shown in FIG. 1, one of the base molds 1 faces the molding mold 2, while the other of the base molds 1 faces the coating mold 6. In the second state, as shown in FIG. 8, the rotating phase is shifted from the first state by 180 degrees and the other of the base molds 1 faces the molding mold 2 while the one of the base molds 1 faces the coating mold 6.

(Molding Mold Clamping/Opening Mechanism 10)

As shown in FIG. 1, FIG. 3 and FIG. 4, the molding mold clamping/opening mechanism 10 includes an upper molding platen 14 with an approximately triangular shape where the molding mold 2 is attached to a lower surface of the upper molding platen 14, three molding guide pillars 15 attached to the lower surface of the upper molding platen 14 at three corners of the upper molding platen 14 where the three molding guide pillars 15 penetrate through the base 13 to allow vertical movement, a lower molding platen 16 having an approximately triangular shape attached to lower ends of the molding guide pillars 15 and a molding drive device (e.g., electric motor) 17 interposed between an upper surface of the lower molding platen 16 and a lower surface of the base 13. Two of the three molding guide pillars 15 located at an outer side are positioned outside the turntable 5 in a radial direction of the turntable 5, and one of the three molding guide pillars 15 located at an inner side is placed in the center hole 5a of the turntable 5. Therefore, the three molding guide pillars 15 do not obstruct the rotation of the turntable 5.

In the molding mold clamping/opening mechanism 10, when the molding drive device 17 is switched from a contracted state shown in FIG. 3 to an expanded state shown in FIG. 4, the lower molding platen 16 moves downward and the upper molding platen 14 moves downward via the molding guide pillars 15. Thus, the molding mold 2 attached to the upper molding platen 14 comes in contact with the base mold 1. As a result, the base mold 1 and the molding mold 2 are clamped together. FIG. 4 is a cross-sectional view showing the state that the molding mold 2 is moved downward by the molding mold clamping/opening mechanism 10 and the coating mold 6 is moved downward by the later described coating mold clamping/opening mechanism 11 in the first state shown in FIG. 1 (state that one of the base molds 1 faces the molding mold 2 while the other of the base molds 1 faces the coating mold 6).

Here, when the turntable 5 is rotated by 180 degrees from the first state where the other of the base molds 1 facing the coating mold 6, the first state is switched to the second state where the other of the molding molds 1 faces the molding mold 2. Thus, the molding mold 2 moved downward when the molding drive device 17 is expanded comes in contact with the other of the base molds 1. Namely, the molding mold clamping/opening mechanism 10 clamps and opens the one of the base molds 1 and the molding mold 2 in the first state shown in FIG. 1. On the other hand, the molding mold clamping/opening mechanism 10 clamps and opens the other of the base molds 1 and the molding mold 2 in the second state where the turntable 5 is rotated by 180 degrees from the first state.

(Coating Mold Clamping/Opening Mechanism 11)

As shown in FIG. 1, FIG. 3 and FIG. 4, the coating mold clamping/opening mechanism 11 includes an upper coating platen 18 having an approximately triangular shape where the coating mold 6 is attached to a lower surface of the upper coating platen 18, three coating guide pillars 19 attached to the lower surface of the upper coating platen 18 at three corners of the upper molding platen 14 where the three coating guide pillars 19 penetrate through the base 13 so as to be vertically movable, a lower coating platen 20 having an approximately triangular shape attached to lower ends of the coating guide pillars 19 and a coating drive device (e.g., electric motor) 21 interposed between an upper surface of the lower coating platen 20 and a lower surface of the base 13. Two of the three coating guide pillars 19 located at an outer side are positioned outside the turntable 5 in a radial direction of the turntable 5, and one of the three coating guide pillars 19 located at an inner side is placed in the center hole 5a of the turntable 5. Thus, the three coating guide pillars 19 do not obstruct the rotation of the turntable 5.

In the coating mold clamping/opening mechanism 11, when the coating drive device 21 is switched from a contracted state shown in FIG. 3 to an expanded state shown in FIG. 4, the lower coating platen 20 moves downward and the upper coating platen 18 moves downward via the coating guide pillars 19. Thus, the coating mold 6 attached to the upper coating platen 18 comes in contact with the base mold 1. Consequently, the base mold 1 and the coating mold 6 are clamped together. Note that the molding base 4 molded in the previous process is attached to the base mold 1. FIG. 4 is a cross-sectional view showing the state that coating mold 6 is moved downward by the coating mold clamping/opening mechanism 11 and the molding mold 2 is moved downward by the above described molding mold clamping/opening mechanism 10 in the first state shown in FIG. 1 (state that one of the base molds 1 faces the molding mold 2 while the other of the base molds 1 faces the coating mold 6).

Here, when the turntable 5 is rotated by 180 degrees from the first state where the one of the base molds 1 facing the molding mold 2, the first state is switched to the second state where the one of the molding molds 1 faces the coating mold 6. Thus, coating mold 6 moved downward when the coating drive device 21 is expanded comes in contact with the one of the base molds 1. Namely, the coating mold clamping/opening mechanism 11 clamps and opens the other of the base molds 1 and the coating mold 6 in the first state shown in FIG. 1. On the other hand, the coating mold clamping/opening mechanism 11 clamps and opens the one of the base molds 1 and the coating mold 6 in the second state, which is achieved by rotating the turntable 5 by 180 degrees from the first state.

(Molding Core 22)

As shown in FIG. 1 and FIG. 3, a plurality of (e.g., four) molding cores 22 are protruded from the upper surface (parting surface) on each of the one of the base molds 1 and the other of the base molds 1. While the present embodiment utilizes four molding cores 22, the number of the molding cores 22 is not limited as long as there are two or more. Both of the one of the base molds 1 and the other of the base molds 1 have the same number of the molding cores 22. The shape of the molding cores 22 is same in both the one of the base molds 1 and the other of the base molds 1. The shape of the molding cores 22 is same between the one of the base molds 1 and the other of the base molds 1. While the molding cores 22 have a rectangular parallelopiped shape in the present embodiment, the shape of the molding cores 22 is not limited to the rectangular parallelopiped shape.

(Molding Cavity 23)

As shown in FIG. 1 and FIG. 3, a plurality of (four in the present embodiment) molding cavities 23 are recessed from the lower surface (parting surface) of the molding mold 2 in accordance with the plurality of molding cores 22. The molding cavities 23 are formed slightly larger than the molding cores 22 in a three-dimensional shape (length, width and height). As shown in FIG. 3 and FIG. 4, when the molds are clamped, the molding gap 3 is formed between the molding cavity 23 and the molding core 22 for forming the molding base 4.

(Coating Cavity 24)

As shown in FIG. 1 and FIG. 3, a plurality of coating cavities 24 (four in the present embodiment) are recessed from the lower surface (parting surface) of the coating mold 6 in accordance with the plurality of molding cores 22. The coating cavities 24 are formed with slightly larger dimensions compared to the molding cavities 23 in a three-dimensional shape (length, width and height). As shown in FIG. 3 and FIG. 4, when the molds are clamped, the coating gap 7 is formed between the coating cavity 24 and the molding base 4 held by the molding core 22 for injecting the coating agent into the coating gap 7.

(Plasticizing Injection Unit 26)

As shown in FIG. 1, an auxiliary base 25 is provided beside the base 13. As shown in FIGS. 3 and 4, a plasticizing injection unit 26 for injecting the thermoplastic resin into the molding gap 3 is provided on the auxiliary base 25 so that the plasticizing injection unit 26 can be freely moved along the radial direction of the turntable 5. In the first state, when the one of the base molds 1 and the molding mold 2 are clamped together by the molding mold clamping/opening mechanism 10, the plasticizing injection unit 26 injects the thermoplastic resin into the molding gap 3 formed between the molding core 22 of the one of the base molds 1 and the molding cavity 23. In the second state where the turntable 5 is rotated by 180 degrees from the first state, when the other of the base molds 1 and the molding mold 2 are clamped together by the molding mold clamping/opening mechanism 10, the plasticizing injection unit 26 injects the thermoplastic resin into the molding gap 3 formed between the molding core 22 of the other of the base molds 1 and the molding cavity 23.

(Thermoplastic Resin)

As the examples of the thermoplastic resin injected from the plasticizing injection unit 26, polyolefin resins such as polyethylene, polypropylene and ethylene-vinyl acetate polymer, crystalline commodity resins such as polyvinyl alcohol, crystalline engineering plastics such as polyamide, polyethylene terephthalate and polyacetal, amorphous commodity resins such as polyvinyl chloride, polyvinylidene chloride, ABS resin, AES resin, ASA resin and PMMA resin, amorphous engineering plastics such as polycarbonate, modified PPO, polyimide, polyarylate and polyetherimide, polystyrene resin, thermoplastic elastomer and the like can be listed. It is also possible to use the above described thermoplastic resins in a mixed state.

It is also possible to use the mixture formed by mixing the thermosetting resins such as polyurethane resin, phenol resin, melamine resin and epoxy resin with the various thermoplastic resins described above within the range where the thermoplastic property is maintained, for example. Furthermore, it is also possible to use the composite material formed by incorporating various fibers such as carbon fiber and glass fiber to the various materials described above. In the specification of the present invention, the thermoplastic resin forming the molding base 4 (shown in FIG. 9B) is illustrated by hatching.

(Sprue Groove 27, Runner Groove 28)

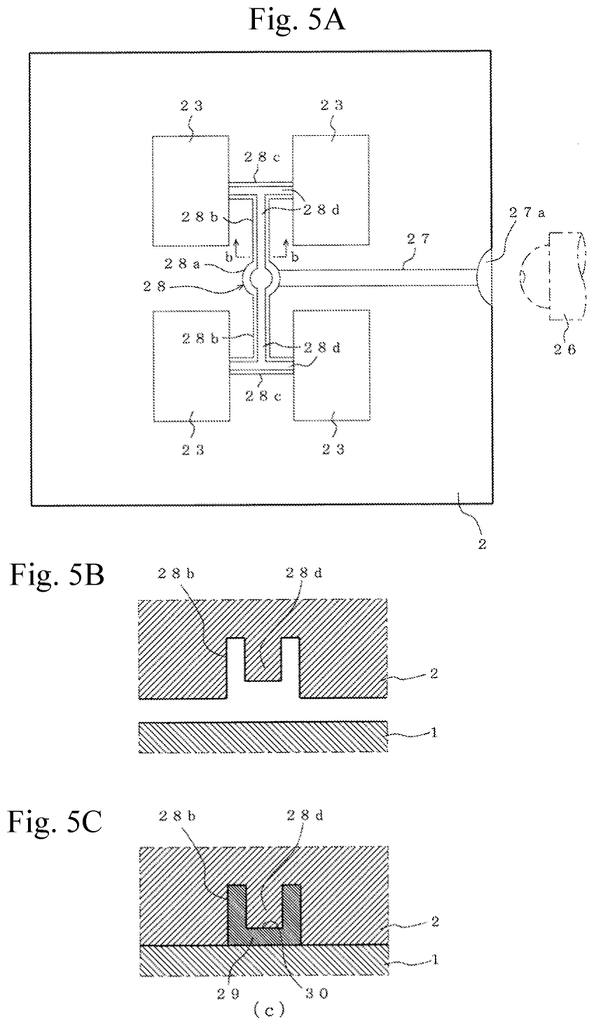

As shown in FIG. 1 and FIG. 5A, a sprue groove 27 and a runner groove 28 are formed on the lower surface (parting surface) of the molding mold 2 so that the thermoplastic resin injected from the plasticizing injection unit 26 is guided into the molding cavities 23 (more precisely, the molding gap 3 shown in FIG. 4). One end of the sprue groove 27 is connected to an injection port 27a formed on (recessed from) a side (lateral) part of the molding mold 2 while the other end of the sprue groove 27 is connected to a central part 28a of the runner groove 28. The runner groove 28 is a so-called tournament-type where the distances from the central part 28a to each of the molding cavities 23 are equal to each other. The runner groove 28 includes the central part 28a having a columnar shape connected to the sprue groove 27, a first groove portion 28b extended in the vertical direction of FIG. 5A from the central part 28a and second groove portion 28c extended in the horizontal direction of FIG. 5A from the first groove portion 28b so as to be connected to four molding gaps 3.

As shown in FIG. 5B, a projected portion 28d is formed on a ceiling surface of the first groove portion 28b recessed from the lower surface (parting surface) of the molding mold 2 along the longitudinal direction of the first groove portion 28b. As shown in FIG. 5C, when the lower surface (parting surface) of the molding mold 2 and the upper surface (parting surface) of the base mold 1 are brought into contact and the thermoplastic resin injected from the plasticizing injection unit 26 is injected into the gap between them, a recessed portion 30 is formed on a formed runner 29 so that the thermosetting resin flows into the recessed portion 30 as a coating agent (shown in FIG. 6). In addition, the second groove portion 28c and the central part 28a shown in FIG. 5A have the same configuration. As a result, as shown in FIG. 5A and FIG. 6, the recessed portion 30 is formed on the runner 29 formed by the runner groove 28 (the central part 28a, the first groove portion 28b, the second groove portion 28c, the projected portion 28d) so that the thermosetting resin flows in the recessed portion 30 acting as the coating agent.

(Coating Agent Injector 31)

As shown in FIG. 1 and FIG. 3, a coating agent injector 31 is vertically installed on the upper coating platen 18 of the coating mold clamping/opening mechanism 11 for injecting the thermosetting resin into the coating gap 7 shown in FIG. 4. As shown in FIG. 4, in the first state, when the other of the base molds 1 and the coating mold 6 are clamped together by the coating mold clamping/opening mechanism 11, the coating agent injector 31 injects the thermosetting resin into the coating gap 7 formed between the molding base 4 held by the molding core 22 of the other of the base molds 1 and the coating cavity 24. In the second state where the turntable 5 is rotated by 180 degrees from the first state, when the one of the base molds 1 and the coating mold 6 are clamped together by the coating mold clamping/opening mechanism 11, the coating agent injector 31 injects the thermosetting resin into the coating gap 7 formed between the molding base 4 held by the molding core 22 of the one of the base molds 1 and the coating cavity 24.

(Thermosetting Resin)

As the thermosetting resin injected from the coating agent injector 31, a thermosetting coating agent is used, for example. After the thermosetting coating agent is injected into the coating gap 7 from the coating agent injector 31, the thermosetting coating agent is hardened by thermal reaction using the coating mold 6 as a heat source and adhered to the outer surface of the molding base 4. A heater is built in the coating mold 6 for heating and hardening the thermosetting coating agent inside the coating gap 7. As the heater, the heater formed by arranging an electric resistance wire such as a nichrome wire near the coating cavity 24 of the coating mold 6 can be used, for example. As the heating method, temperature controllability is required. When the setting temperature is 120° C. or below, a water temperature adjustment is used, while an oil temperature adjustment is used when the setting temperature exceeds 120° C.

As the thermosetting coating agent, in addition to alkyd resin series, epoxy resin series, polyurethane series and vinyl resin series, epoxy acrylate oligomer, urethane acrylate oligomer, polyester acrylate oligomer, radical polymerization type coating materials formed by the above described various oligomers and ethylenically unsaturated monomer, oxidation polymerization type coating materials of alkyd resin series, epoxy resin ester series and fatty acid modified urethane resin series, multi-liquid reaction type coating materials of epoxy resin series, polyurethane series and unsaturated polyester series, functional coating materials formed by adding metal powders, pigments or ultraviolet absorbers to the above described coating materials, fluorocarbon resin-based lacquer, silicon resin-based lacquer and silane-based hard coating agent can be used, for example. In the specification of the present invention, the thermosetting resin coated on the outer surface of the molding base 4 to form the coating layer 8 (shown in FIG. 9B) is illustrated by dots.

(Coating Agent Sprue Passage 32, Coating Agent Groove 33)

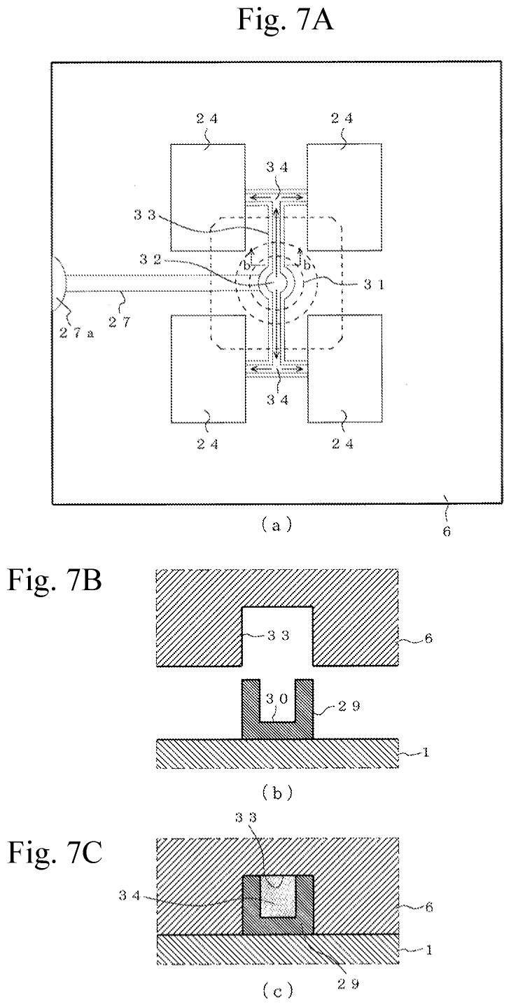

As shown in FIG. 1 and FIG. 7A, a coating agent sprue passage 32 and a coating agent groove 33 are formed on the lower surface (parting surface) of the coating mold 6 so that the thermosetting resin injected from the coating agent injector 31 is guided into the coating cavities 24 (more precisely, the coating gap 7 shown in FIG. 4). As shown in FIG. 4, one end of the coating agent sprue passage 32 is connected to an injection port of the coating agent injector 31 while the other end of the coating agent sprue passage 32 is connected to the central part of the tournament-type runner 29 (shown in FIG. 6). As shown in FIG. 7B, the coating agent groove 33 is recessed from the lower surface (parting surface) of the coating mold 6 in accordance with the width and the height of the runner 29.

As shown in FIG. 7C, when the lower surface (parting surface) of the coating mold 6 and the upper surface (parting surface) of the base mold 1 are brought into contact, the recessed portion 30 formed on the runner 29 is covered by the ceiling surface of the coating agent groove 33 and a passage 34 is formed so that the thermosetting resin injected from the coating agent injector 31 (shown in FIG. 4) flows through in the passage 34. Since the passage 34 is formed along the so-called tournament-type runner 29 (shown in FIG. 6), the distances from the injection port of the coating agent injector 31 to each of the coating cavities 24 (more precisely, the coating gap 7 shown in FIG. 4) are equal to each other. As shown by the broken lines in FIG. 7A, the coating agent injector 31 is arranged at an approximately center of the coating mold 6 and at the center part of the four coating cavities 24. Thus, the distance from the injection port of the coating agent injector 31 to each of the coating cavities 24 (more precisely, the coating gap 7 shown in FIG. 4) is minimum.

(Mold Clamping Force, Duration Time of Clamping, Mold Clamping Timing and Mold Temperature)

In the present invention, as shown in FIG. 3 and FIG. 4, since the molding mold clamping/opening mechanism 10 which clamps and opens the base mold 1 and the molding mold 2 for forming the molding base 4 from the thermoplastic resin is provided separately from the coating mold clamping/opening mechanism 11 which clamps and opens the base mold 1 and the coating mold 6 for coating the surface of the molding base 4 with the thermosetting resin, the optimum molding conditions for the molding of the molding base 4 using the thermoplastic resin as the material and the optimum coating conditions for the coating using the thermosetting resin as the material can be specified independently.

Specifically, at least one of the mold clamping force between the base mold 1 and the molding mold 2, the duration time of clamping between the base mold 1 and the molding mold 2, the mold clamping timing between the base mold 1 and the molding mold 2 and the mold temperature of the molding mold 1 when injection-molding the molding base 4 from the thermoplastic resin by the molding mold clamping/opening mechanism 10 is different from the mold clamping force between the base mold 1 and the coating mold 6, the duration time of clamping between the base mold 1 and the coating mold 6, the mold clamping timing between the base mold 1 and the coating mold 6 and the mold temperature of the coating mold 6 when coating the molding base 4 with the thermosetting resin by the coating mold clamping/opening mechanism 11.

For more details, the mold clamping force between the base mold 1 and the molding mold 2 when injection-molding the molding base 4 from the thermoplastic resin using the molding mold clamping/opening mechanism 10 is greater than the mold clamping force between the base mold 1 and the coating mold 6 when coating the molding base 4 with the thermosetting resin using the coating mold clamping/opening mechanism 11, and the duration time of clamping between the base mold 1 and the molding mold 2 when injection-molding the molding base 4 from the thermoplastic resin using the molding mold clamping/opening mechanism 10 is shorter than the duration time of clamping between the base mold 1 and the coating mold 6 when coating the molding base 4 with the thermosetting resin using the coating mold clamping/opening mechanism 11. The following is a detailed explanation.

(Mold Clamping Force)

It is common for both the thermoplastic resin (molding resin) and the thermosetting resin (coating resin) that the mold clamping force is required in order to prevent the contraction and the deformation after the resins have solidified. It should be noted that the thermosetting resin such as phenol resin and melamine resin has a property that the fluidity is increased as the pressure to be applied becomes larger. Thus, unless an appropriate mold clamping force is selected, there is a possibility of defects in the outer appearance due to burrs. In the injection molding, the mold clamping force is calculated as follows.

F=p×A
F: required mold clamping force; p: injection pressure; A: projected area of molded product

An example of the calculation of the mold clamping force of the molding base part and the coating part calculated by using the above described formula is shown below. The injection pressure p is determined by the fluidity of the material and the shape of the molded product. In the following calculation, general values are shown. The projected area of the coating part is shown as a ratio in condition that the projected area of the molding base part is 100%.

| | injection | projected | mold clamping |
|---|---|---|---|
| | pressure p | area A | force F |
| molding base part | 20 to 40 MPa × | 100% = | 2000 to 4000 |
| coating part | 2 to 3 MPa × | 90 to several % = | 2 to 270 |

From the above, it is understood that the ratio of the mold clamping force between the molding base part and the coating part is approximately 100:5. Since the molding process and the coating process are separated from each other, the optimum mold clamping force can be selected respectively for the molding base part of the thermoplastic resin and the coating part of the thermosetting resin when the material characteristic and the projected area are different between them.

(Duration Time of Clamping: (Molding Cycle))

For the thermoplastic resin, the duration time of clamping is approximately equal to the cooling time. The cooling proceeds based on the heat conduction of the resin material. In the thermosetting resin, the duration time of clamping is approximately equal to the hardening time (curing time). The chemical reaction is accelerated by heating and the speed of hardening is quicker as the temperature becomes high. In both the thermoplastic resin and the thermosetting resin, the clamping time accounts for a significant portion of the molding cycle, and the clamping time increases as the thickness of the molded product increases.

When a flat plate having a thickness of 1 mm is considered, the clamping time is approximately 10 to 20 seconds in the thermoplastic resin such as PC, PS and ABS, while the clamping time is approximately 50 to 60 seconds in the thermosetting resin such as phenol resin as the standard. Although the hardening time of the thermosetting resin can be shortened to approximately one-third by performing preheating (80 to 120° C. in phenol resin) before injecting the resin, the required time is still longer compared to the thermoplastic resin. Namely, the duration time of clamping is shorter in the thermoplastic resin compared to the thermosetting resin.

(Mold Clamping Timing)

As for the mold clamping timing, the differences between the thermoplastic resin and the thermosetting resin are listed below.

Regarding the thermoplastic resin, as an advanced molding method for improving the productivity, it is possible to fill a molten resin in a state that the molds are slightly opened, perform the final clamping of the molds during the injection of the resin or immediately before finishing the injection of the resin and reduce the mold clamping force after the completion of pressure holding. Because of this, the contraction amount inside the molded product can be even. Thus, the molded product having a small residual strain and uniform thickness can be obtained. The above described method is especially efficient for thin molded products and practically used for forming optical lens and the like.

Regarding the thermosetting resin, when the thermosetting resin is heated, volatile substance and moisture within the resin are evaporated leading to an impact on the outer appearance of the molded product. Therefore, a degassing operation is performed to release the gas. After the molding material is entered into the molds and the softened material is spread entirely in the molds, the molds are instantaneously opened to release the gas generated from the resin outside the molds. Then, a predetermined mold clamping force is applied to harden the resin. The above described process is important especially in the molding of phenol resin, urea resin and melamine resin.

The clamped states of the above described molding methods are compared in the following table in accordance with the flow of the molding processes. In the following table, o indicates the processes corresponding to the thermoplastic resin and □ indicates the processes corresponding to the thermosetting resin.

| | (flow of molding) | | | |
|---|---|---|---|---|
| | before | start to finish | | finish pressure |
| | injecting resin | of injection | pressure holding | holding to extraction |
| completely | ◯◯◯◯◯◯◯◯ | | | ◯◯◯◯◯ |
| mold opening | □□□□□□□□ | | | □□□□□□□□□ |
| slightly mold | ◯◯◯◯◯◯◯◯◯ | | | |
| opening state | | □□□□ | | |
| low pressure | | | | ◯◯◯◯◯ |
| mold clamping | □□□□□□□□□□□□ | | | |
| final mold | | ◯◯◯◯◯◯◯◯◯◯◯◯◯◯◯ | | |
| clamping | | | □□□□□□□ | |

The above described table is the explanation drawing of the mold clamping timing indicating the order of each process (completely mold opening state, slightly mold opening state, low pressure mold clamping, final mold clamping) and the rate of the time of each process with respect to the entire cycle for the thermoplastic resin (∘) and the thermosetting resin (□) in condition that the molding time from “before injecting resin” to “extraction” is virtually equal between the thermoplastic resin and the thermosetting resin. As described above, the actual duration time of clamping is longer in the thermoplastic resin compared to the thermosetting resin.

In case of the thermoplastic resin, the processes are shifted in the order of “completely mold opening state,” “slightly mold opening state,” “final mold clamping,” “low pressure mold clamping” and “completely mold opening state” connecting ∘ and ∘ with each other in accordance with the flow of the molding process is shifted in the order of “before injecting resin,” “start to finish of injection,” “pressure holding” and “finish pressure holding to extraction.” In case of the thermosetting resin, the processes are shifted in the order of “completely mold opening state,” “low pressure mold clamping,” “slightly mold opening state,” “final mold clamping” and “completely mold opening state” connecting □ and □ with each other in accordance with the flow of the molding process is shifted in the order of “before injecting resin,” “start to finish of injection,” “pressure holding” and “finish pressure holding to extraction.”

The above described processes are performed for the purpose of efficiently releasing the air or the gas trapped inside the molds. However, there are differences in behavior between the thermoplastic resin and the thermosetting resin. In the present embodiment, as shown in FIG. 1 and other figures, the molding process of the thermoplastic resin injected from the plasticizing injection unit 26 and the coating process of the thermosetting resin injected from the coating agent injector 31 can be independently performed by the molding mold clamping/opening mechanism 10 and the coating mold clamping/opening mechanism 11 respectively. Thus, the above described molding processes, which exhibit different behaviors, can be separately performed.

(Mold Temperature)

The purpose of adjusting the temperature is different between the thermoplastic resin and the thermosetting resin. In the thermoplastic resin, the resin is cooled to remove the applied fluidity (reversible physical change). In the thermosetting resin, the resin is heated for enhancing the chemical reaction (irreversible physical change). Since the purpose is opposite direction (heat to cool, cool to heat), the temperature of the mold (molding mold 2) of the thermoplastic resin tends to be relatively low and the temperature of the mold (coating mold 6) of the thermosetting resin tends to be relatively high. Concrete examples are shown below.

| | | mold temperature |
|---|---|---|
| | | (° C.) |
| thermoplastic resin | PS | 80 |
| | PA | 50 |
| | PC | 100 |
| | PEEK | 150 |
| thermosetting resin | phenol resin (resol) | 130 to 160 |
| | acryl resin | 100 to 160 |

In the following table, the mold clamping force, the duration time of clamping, the mold clamping timing and the mold temperature described above are summarized for both the molding process (thermoplastic resin) and the coating process (thermosetting resin).

| | | mold | duration time | mold | mold tem- |
|---|---|---|---|---|---|
| | | clamping | of clamping | clamping | perature |
| | resin | force | (molding cycle) | timing | ° C. |
| molding | thermo- | large | short | respectively | 50 to 150 |
| process | plastic | | | special with | |
| | property | | | molding | |
| coating | thermo- | small | long | technique | 100 to 160 |
| process | setting | | | | |
| | property | | | | |

As for the mold clamping force, since the mold clamping force of the molding process is larger compared to the coating process, as shown in FIG. 1 and other figures, the upper molding platen 14 and the lower molding platen 16 of the molding mold clamping/opening mechanism 10 are thicker than the upper coating platen 18 and the lower coating platen 20 of the coating mold clamping/opening mechanism 11 and the diameter of the molding guide pillars 15 of the molding mold clamping/opening mechanism 10 is larger than the diameter of the coating guide pillars 19 of the coating mold clamping/opening mechanism 11. In addition, as shown in FIG. 3 and FIG. 4, the molding drive device 17 of the molding mold clamping/opening mechanism 10 is larger (higher output) than the coating drive device 21 of the coating mold clamping/opening mechanism 11.

As for the duration time of clamping, since the duration time of clamping of the molding process is shorter compared to the duration time of clamping of the coating process, a controller (computer) that controls the molding drive device 17 of the molding mold clamping/opening mechanism 10 and the coating drive device 21 of the coating mold clamping/opening mechanism 11 independently controls the duration time of clamping of the molding process and the duration time of clamping of the coating process so that the former is shorter than the latter and both of them are optimized.

As for the mold clamping timing, since the special techniques exist respectively for the molding process and the coating process, the molding drive device 17 of the molding mold clamping/opening mechanism 10 and the coating drive device 21 of the coating mold clamping/opening mechanism 11 are separately controlled to expand and contract by the controller (computer) that controls them in accordance with the technique of the molding process and the technique of the coating process.

As for the mold temperature, since different optimum temperatures exist separately for the molding process and the coating process, the temperature of the molding mold 2 and the temperature of the coating mold 6 are adjusted in accordance with the optimum temperature. Specifically, a cold water circuit, a hot water circuit, a heater and the like for adjusting the temperature is respectively provided on the molding mold 2 and the coating mold 6. By utilizing them, the temperature of the molding mold 2 and the temperature of the coating mold 6 are adjusted to the optimum temperature in accordance with the molding process and the coating process.

The concrete temperature of the molding mold 2 and the concrete temperature of the coating mold 6 differs depending on the kind (e. g., PS, PA, PC, PEEK) of the thermoplastic resin formed by the molding mold 2 and the kind (e.g., phenol resin (resol), acryl resin) of the thermosetting resin coated by the coating mold 6. However, in general, the temperature of the molding mold 2 forming the thermoplastic resin is specified to be lower than the temperature of the coating mold 6 for coating the thermosetting resin and a cooling means such as a cold water circuit is installed on the molding mold 2 and a heating means such as a heater and a hot water circuit is installed on the coating mold 6.

(About Each Process)

Hereafter, the processes of the manufacturing method of the in-mold-coated molded product of the present embodiment will be explained while dividing the processes into the molding process and the coating process.

(Molding Process)

First, the molding process using the molding mold 2 and the base mold 1 and using the thermoplastic resin as the material will be explained.

(1) The process starts from the state of FIG. 1 and FIG. 3. However, the molding base 4 held by the left base mold 1 does not exist in the initial state.

(2) As shown in FIG. 4, the upper molding platen 14 is lowered by the molding mold clamping/opening mechanism 10. Thus, the molding mold 2 is lowered and the molding mold 2 and the base mold 1 are clamped together. At this point, the molding gap 3 is created within the molding cavity 23 between the molding core 22 and the molding mold 2 of the base mold 1.

(3) As shown in FIG. 4, the plasticizing injection unit 26 is moved forward and a nozzle portion of the plasticizing injection unit 26 is connected to the injection port 27a that is recessed from the parting surface between the molding mold 2 and the base mold 1.

(4) The thermoplastic resin in a melted state is injected from the nozzle portion of the plasticizing injection unit 26, the injected thermoplastic resin passes through the sprue groove 27 and the runner groove 28 shown in FIG. 5A and the thermoplastic resin is injected and filled into the molding gap 3 formed between the molding cores 22 and the molding cavities 23 shown in FIG. 4 until the molding gap 3 is fully packed.

(5) After the cooling of the molten thermoplastic resin injected into the molding gap 3 shown in FIG. 4 has finished and the thermoplastic resin is solidified, the plasticizing injection unit 26 is retracted and the nozzle portion of the plasticizing injection unit 26 is separated from the injection port 27a. followed by the upper molding platen 14 is moved upward by the molding mold clamping/opening mechanism 10. Thus, the molding mold 2 is moved upward, resulting in the opening of the molding mold 2 and the base mold 1. At this time, as shown in FIG. 8, the molding base 4 formed from the thermoplastic resin is held by the molding core 22 of the base mold 1. To facilitate the understanding of the shape of the molding base 4, FIG. 6. shows the molding base 4 that is virtually removed from the molding core 22.

(6) As shown in FIG. 8, in a state that the molding base 4 is still held by the molding core 22 of the base mold 1, the turntable 5 is rotated by 90 degrees as shown in FIG. 9A.

(7) In the above described state, when the coated molding base 4 (in-mold-coated molded product 9) is attached to the molding core 22 of the other of the base molds 1, the in-mold-coated molded product 9 is removed from the molding cores 22 using a not-illustrated eject mechanism. (The second cycle of the manufacturing of the manufacturing device will be described later in the coating process.)

(8) The turntable 5 is further rotated by 90 degrees from the state shown in FIG. 9A to the state shown in FIG. 1, the base mold 1 to which the molding base 4 is attached faces the coating mold 6, while the other base mold 1 to which the molding base 4 is not attached faces the molding mold 2.

(9) Then, the above described processes (2) to (8) are repeated.

(Coating Process)

Next, the coating process using the coating mold 6 and the base mold 1 and using the thermosetting resin as the material will be explained.

(10) The coating process starts at the same time as the molding process explained in (1) to (9) starts. The process starts from the state of FIG. 1 and FIG. 3. The process starts from the state of FIG. 1 and FIG. 3. The molding base 4 (made of the thermoplastic resin) formed in the previous molding process is held by the left base mold 1.

(11) Starting from the state shown in FIG. 1 and FIG. 3, the upper coating platen 18 is lowered using the coating mold clamping/opening mechanism 11. Thus, the coating mold 6 is lowered, and then the coating mold 6 and the base mold 1 are clamped together as shown in FIG. 4. At this time, the coating gap 7 is formed between the molding base 4 held by the molding core 22 of the base mold 1 and the coating cavity 24 of the coating mold 6.

(12) As shown in FIG. 4, the thermosetting resin is injected from the coating agent injector 31 provided on the upper coating platen 18. The injected thermosetting resin passes through the coating agent sprue passage 32 shown in FIG. 4 and the coating agent groove 33 shown in FIG. 7A and the thermosetting resin is injected and filled into the coating gap 7 shown in FIG. 4.

(13) Here, as shown in FIG. 7A, the coating agent injector 31 is arranged at approximately the center of the coating mold 6 and the thermosetting resin injected from the coating agent injector 31 flows into the passage 34 (shown in FIG. 7C) formed on the tournament-type runner 29 (shown in FIG. 6). Thus, the thermosetting resin is injected from the coating agent injector 31 into the coating gap 7 (shown in FIG. 4) in each of the coating cavities 24 ensuring even distribution and the shortest distance.

(14) After the hardening reaction of the thermosetting resin injected into each of the coating gaps 7 shown in FIG. 4 is finished, the upper coating platen 18 is moved upward by the coating mold clamping/opening mechanism 11 as shown in FIG. 8. Thus, the coating mold 6 is moved upward, opening the coating mold 6 and the base mold 1. At this time, the molding base 4 (in-mold-coated molded product 9) after the coating is performed is held by the molding core 22 of the base mold 1.

(15) As shown in FIG. 8, once both the molding process of forming the molding base 4 from the thermoplastic resin by the molding mold 2 and the one of the base molds 1 and the coating process of coating the surface of the molding base 4 with the thermosetting resin by the coating mold 6 and the other of the base molds 1 are completed and the molds are opened, the turntable 5 is rotated by 90 degrees as shown in FIG. 9A.

(16) As shown in FIG. 9A, after the coating is performed, the molding base 4 (in-mold-coated molded product 9) that is attached to the molding cores 22 of the base mold 1 is detached from the molding cores 22 using a not-illustrated eject mechanism. The removed product (in-mold-coated molded product 9), where four products are connected by the runner 29, is cut at the part of the runner 29. Thus, four independent in-mold-coated molded products 9 are formed. As shown in FIG. 9B, the in-mold-coated molded product 9 is formed by the molding base 4, made of the thermoplastic resin, and the coating layer 8, made of the thermosetting resin, coated on the surface of the molding base 4.

(17) The turntable 5 is further rotated by 90 degrees from the state shown in FIG. 9A to the state shown in FIG. 1, the base mold 1 not holding anything faces the molding mold 2 and the other base mold 1 holding the molding base 4 formed by the simultaneously performed molding process faces the coating mold 6.

(18) Then, the above described processes (10) to (17) are repeated.

As described above, since the manufacturing efficiency of the in-mold-coated molded product 9 is improved compared to the conventional so-called core back method by performing the coating process with the thermosetting resin simultaneously during the molding process with the thermoplastic resin. In addition, since the molding process is performed by the molding mold clamping/opening mechanism 10 independently from the coating process performed by the coating mold clamping/opening mechanism 11, the optimum molding conditions for the molding of the molding base using the thermoplastic resin as the material and the optimum coating conditions for the coating using the thermosetting resin as the material can be specified independently. This ensures both the quality of the molding base 4 and the quality of the coating layer 8 in the manufactured in-mold-coated molded product 9.

### MODIFIED EXAMPLES OF EMBODIMENTS

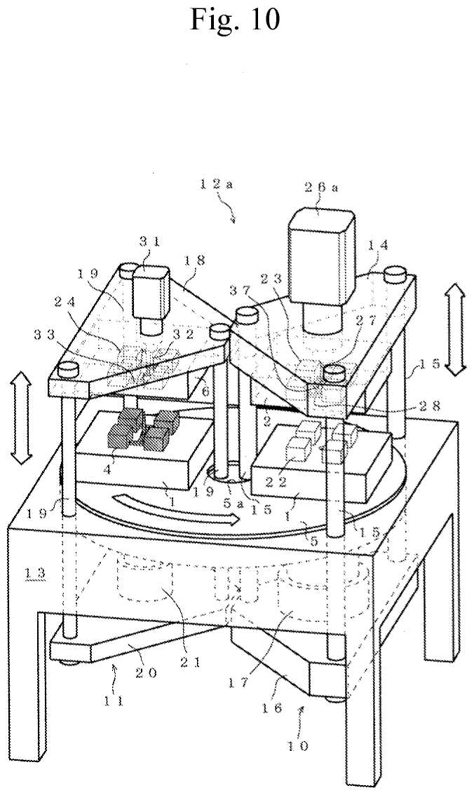

FIG. 10 shows the manufacturing device (vertical injection) 12a of the in-mold-coated molded product 9 concerning a modified embodiment of the present invention. The manufacturing device (vertical injection) 12a of the in-mold-coated molded product 9 differs from the manufacturing device (horizontal injection) 12 of the in-mold-coated molded product 9 shown in FIG. 1 shown as the previous embodiment, in a point that a plasticizing injection unit 26a is attached to the upper molding platen 14 of the molding mold clamping/opening mechanism 10. The other configurations are the same as in the previous embodiment. Therefore, the explanation of the same configurations as the previous embodiment is omitted by assigning the same reference numeral. Only the difference will be explained below.

When comparing FIG. 10 (modified embodiment) with FIG. 1 (previous embodiment), it becomes evident that the modified embodiment shown in FIG. 10 is of the vertical injection type where the plasticizing injection unit 26a is installed vertically on the upper molding platen 14. Unlike the previous embodiment which is of the horizontal injection type shown in FIG. 1, in the modified embodiment, the sprue groove 27 formed on the parting surface of the base mold 1 is no longer necessary.

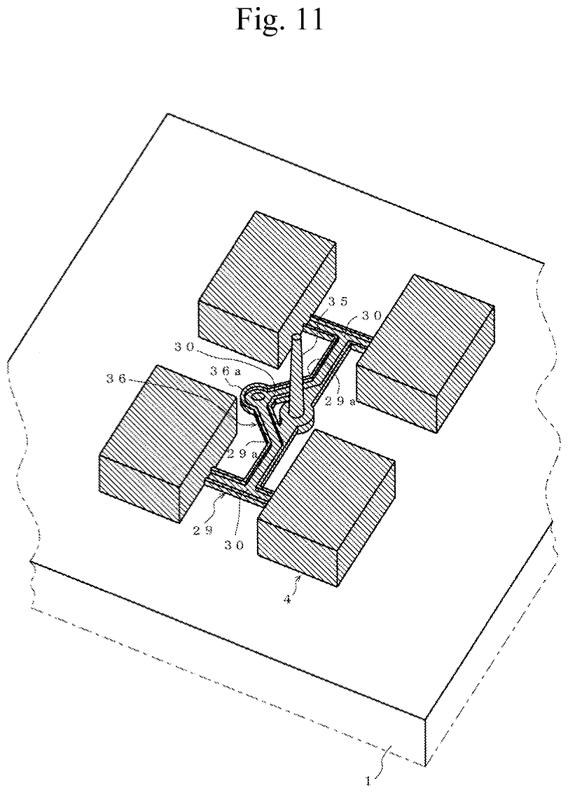

Four molding cavities 23, a runner groove 28 and a sprue passage 27 are formed on the molding mold 2 of the modified embodiment shown in FIG. 10 for molding the molding base 4 shown in FIG. 11. An upper end of the sprue passage 27 is connected to the injection port of the plasticizing injection unit 26a and a lower end of the sprue passage 27 is arranged at the center of the four molding cavities 23. The runner groove 28 is designed as a tournament-type where the distances from the sprue passage 27 located at the center to each of the molding cavities 23 are equal to each other. In addition, a bypass runner groove 37 is formed on the molding mold 2 shown in FIG. 10 to create a bypass runner 36, which connects to the runner 29 shown in FIG. 11, thereby avoiding a sprue 35 (sprue 35 formed by sprue passage 27) located at the center. The recessed portion 30 is formed on the bypass runner 36 and the runner 29 in order to allow the thermosetting resin injected from the coating agent injector 31 to flow in the recessed portion 30.

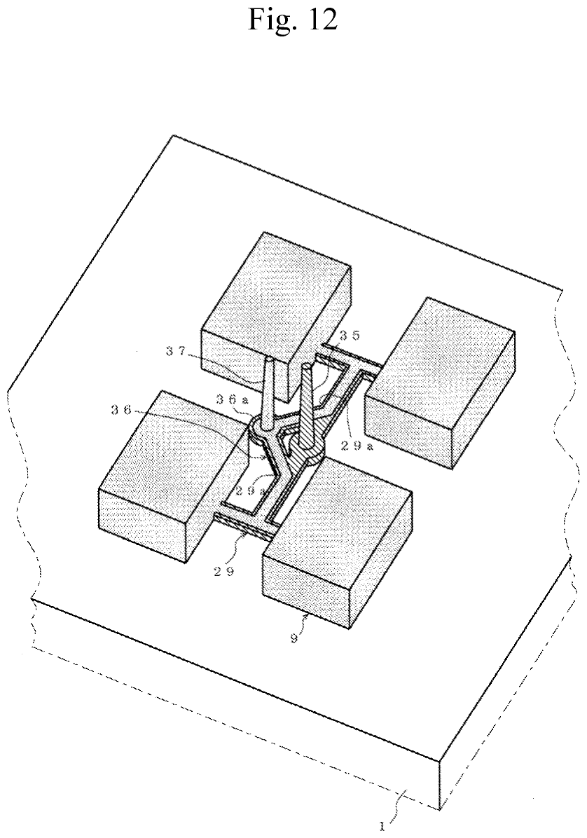

On the other hand, in the modified embodiment shown in FIG. 10, to perform the coating shown in FIG. 12 on the molding base 4 shown in FIG. 11, four coating cavities 24, a coating agent sprue passage 32 and a coating agent groove 33 are formed on the coating mold 6. An upper end of the coating agent sprue passage 32 is connected to the injection port of the coating agent injector 31 and a lower end of the coating agent sprue passage 32 is connected to an intermediate portion 36a of the bypass runner 36 (shown in FIG. 11). The coating agent groove 33 is formed alongside both the runner 29 and the bypass runner 36 shown in FIG. 11. The intermediate portion 36a of the bypass runner 36 and the runner 29 are connected with each other at two portions (connection portions 29a). The lengths from the connection portion 29a to the intermediate portion 36a are equal to each other. The recessed portion 30 is formed on the runner 29 and the bypass runner 36 so that the thermosetting resin injected from the coating agent injector 31 flows in the recessed portion 30. All the distances from the intermediate portion 36a of the bypass runner 36 to each of the coating cavities 24 are the same.

In the above described configuration, the thermosetting resin injected from the coating agent injector 31 shown in FIG. 10 flows through the coating agent sprue passage 32, the recessed portion 30 of the bypass runner 36 and the recessed portion 30 of the runner 29 shown in FIG. 11 and is injected into the four coating cavities 24 (more precisely, the coating gap 7 formed between the four molding bases 4 and the coating cavities 24 shown in FIG. 4). Here, although a coating agent sprue 37 shown in FIG. 12 formed by the coating agent sprue passage 32 shown in FIG. 10 is not located at the center of the four coating gaps 7, the thermosetting resin injected from the coating agent injector 31 flows along the bypass runner 36 where the lengths from the intermediate portion 36a to each of the connection portions 29a are equal to each other and then flows along the so-called tournament-type runner 29. As a result, the passage lengths are equal to each other in four and this ensures the even distribution of the thermosetting resin into all coating gaps 7. In addition, as shown in FIG. 10, the plasticizing injection unit 26a is always in contact with the molding mold 2. There is no need to move the plasticizing injection unit 26a back and forth as per the processes. Thus, the operation time can be shortened, resulting in a shorter molding cycle compared to the previous embodiment. Except for the above described configurations, basic operation and effect of the modified embodiment are same as those of the previous embodiment.

The preferable embodiments of the present invention are explained above referring to the attached drawings. It goes without saying that the present invention is not limited to the above described embodiments and various modified examples and corrected examples are included in the technical range of the present invention within the range described in the claims.

### INDUSTRIAL APPLICABILITY

The present invention relates to a manufacturing method and a manufacturing device of an in-mold-coated molded product for molding a molding base in molds using a thermoplastic resin and then coating a surface of the molding base with a thermosetting resin in the molds. In particular, the present invention can be used as the manufacturing method and the manufacturing device of the in-mold-coated molded product where the optimum molding conditions for the molding of the molding base using the thermoplastic resin and the optimum coating conditions for the coating using the thermosetting resin can be specified independently.

### DESCRIPTION OF THE REFERENCE NUMERALS

1: base mold; 2: molding mold; 3: molding gap; 4: molding base; 5: turntable; 6: coating mold; 7: coating gap; 8: coating layer; 9: in-mold-coated molded product; 10: molding mold clamping/opening mechanism; 11: coating mold clamping/opening mechanism; 12: manufacturing device of in-mold-coated molded product; 13: base; 22: molding core; 23: molding cavity; 24: coating cavity; 26: plasticizing injection unit; 28: runner groove; 29: runner; 31: coating agent injector; 33: coating agent groove

1. A manufacturing method of an in-mold-coated molded product, the manufacturing method comprising:
clamping a base mold and a molding mold with each other, injecting a thermoplastic resin into a molding gap formed between the base mold and the molding mold and solidifying the thermoplastic resin to form a molding base;
opening the base mold and the molding mold in a state that the molding base is held by the base mold and switching the molding mold facing the base mold to a coating mold; and
clamping the coating mold and the base mold with each other, injecting a thermosetting resin into a coating gap formed between the molding base held by the base mold and the coating mold and hardening the thermosetting resin for coating a surface of the molding base with the thermosetting resin, wherein
a molding mold clamping/opening mechanism for clamping and opening the base mold and the molding mold is provided separately from a coating mold clamping/opening mechanism for clamping and opening the base mold and the coating mold, and
at least one of a mold clamping force between the base mold and the molding mold, a duration time of clamping between the base mold and the molding mold, a mold clamping timing between the base mold and the molding mold and a mold temperature of the molding mold when injection-molding the molding base from the thermoplastic resin by the clamping/opening mechanism is different from the mold clamping force between the base mold and the coating mold, the duration time of clamping between the base mold and the coating mold, the mold clamping timing between the base mold and the coating mold and the mold temperature of the coating mold respectively when coating the molding base with the thermosetting resin by the coating mold clamping/opening mechanism.

2. The manufacturing method of the in-mold-coated molded product according to claim 1, wherein
the mold clamping force between the base mold and the molding mold when injection-molding the molding base from the thermoplastic resin by the molding mold clamping/opening mechanism is larger than the mold clamping force between the base mold and the coating mold when coating the molding base with the thermosetting resin by the coating mold clamping/opening mechanism, and
the duration time of clamping between the base mold and the molding mold when injection-molding the molding base from the thermoplastic resin by the molding mold clamping/opening mechanism is shorter than the duration time of clamping between the base mold and the coating mold when coating the molding base with the thermosetting resin by the coating mold clamping/opening mechanism.

3. A manufacturing device of an in-mold-coated molded product formed by: clamping a base mold and a molding mold with each other, injecting a thermoplastic resin into a molding gap formed between the base mold and the molding mold and solidifying the thermoplastic resin to form a molding base; opening the base mold and the molding mold in a state that the molding base is held by the base mold and switching the molding mold facing the base mold to a coating mold; and clamping the coating mold and the base mold with each other, injecting a thermosetting resin into a coating gap formed between the molding base held by the base mold and the coating mold and hardening the thermosetting resin for coating a surface of the molding base with the thermosetting resin, wherein
a molding mold clamping/opening mechanism for clamping and opening the base mold and the molding mold is provided separately from a coating mold clamping/opening mechanism for clamping and opening the base mold and the coating mold, and
at least one of a mold clamping force between the base mold and the molding mold, a duration time of clamping between the base mold and the molding mold, a mold clamping timing between the base mold and the molding mold and a mold temperature of the molding mold when injection-molding the molding base from the thermoplastic resin by the clamping/opening mechanism is different from the mold clamping force between the base mold and the coating mold, the duration time of clamping between the base mold and the coating mold, the mold clamping timing between the base mold and the coating mold and the mold temperature of the coating mold respectively when coating the molding base with the thermosetting resin by the coating mold clamping/opening mechanism.

4. The manufacturing device of the in-mold-coated molded product according to claim 3, wherein
the mold clamping force between the base mold and the molding mold when injection-molding the molding base from the thermoplastic resin by the molding mold clamping/opening mechanism is larger than the mold clamping force between the base mold and the coating mold when coating the molding base with the thermosetting resin by the coating mold clamping/opening mechanism, and
the duration time of clamping between the base mold and the molding mold when injection-molding the molding base from the thermoplastic resin by the molding mold clamping/opening mechanism is shorter than the duration time of clamping between the base mold and the coating mold when coating the molding base with the thermosetting resin by the coating mold clamping/opening mechanism.

5. The manufacturing device of the in-mold-coated molded product according to claim 3, wherein
a turntable facing the molding mold and the coating mold is provided,
the base mold is comprised of two base molds and the two base molds are installed on the turntable at a 180° interval,
a turntable-rotary-driving portion for rotating the turntable is provided for switching the turntable between a first state where one of the two base molds faces the molding mold and the other of the two base molds faces the coating mold and a second state where the other of the two base molds faces the molding mold and the one of the two base molds faces the coating mold,
the molding mold clamping/opening mechanism is provided on a base which supports the turntable so as to be freely rotatable,
the molding mold clamping/opening mechanism is configured to clamp and open the one of the two base molds and the molding mold in the first state,
the molding mold clamping/opening mechanism is configured to clamp and open the other of the two base molds and the molding mold in the second state,
the coating mold clamping/opening mechanism is provided on the base,
the coating mold clamping/opening mechanism is configured to clamp and open the other of the two base molds and the coating mold in the first state, and
the coating mold clamping/opening mechanism is configured to clamp and open the one of the two base molds and the coating mold in the second state.

6. The manufacturing device of the in-mold-coated molded product according to claim 5, further comprising:
a plurality of molding cores projected respectively from the one of the two base molds and the other of the two base molds so that the number of the plurality of molding cores is same between the one of the two base molds and the other of the two base molds;
a plurality of molding cavities recessed from the molding mold in accordance with the plurality of molding cores;
a plurality of coating cavities recessed from the coating mold in accordance with the plurality of molding cores;
a plasticizing injection unit configured to inject the thermoplastic resin into the molding gap formed between the plurality of molding cores and the plurality of molding cavities when the one of the two base molds and the molding mold are clamped together or the other of the two base molds and the molding mold are clamped together by the molding mold clamping/opening mechanism; and
a coating agent injector configured to inject the thermosetting resin into the coating gap formed between the molding base held by the plurality of molding cores and the plurality of coating cavities when the other of the two base molds and the coating mold are clamped together or the one of the two base molds and the coating mold are clamped together by the coating mold clamping/opening mechanism.

7. The manufacturing device of the in-mold-coated molded product according to claim 6, wherein
the coating agent injector is arranged at an approximately center of the coating mold so that injection distances to the plurality of coating cavities are equal to each other.

8. The manufacturing device of the in-mold-coated molded product according to claim 7, wherein
a runner groove is formed on the molding mold so that the thermoplastic resin injected from the plasticizing injection unit is guided into the molding gap formed between the plurality of molding cores and the plurality of molding cavities at a constant length when the molding mold is clamped with the one of the two base molds or the other of the two base molds, and
a coating agent groove is formed on the coating mold so that the thermosetting resin injected from the coating agent injector is guided into the coating gap formed between the molding base held by the plurality of molding cores and the plurality of coating cavities at a constant length along a runner formed by the runner groove when the coating mold is clamped with the other of the two base molds or the one of the two base molds.
